(19) United States
(12) Patent Application Publication
(10) Pub. No.: US 2019/0347287 A1
(43) Pub. Date: Nov. 14, 2019

(54) METHOD FOR SCREENING AND INJECTION OF MEDIA CONTENT BASED ON USER PREFERENCES

(71) Applicants: Adam Thomas Crossno, Argyle, TX (US); John Mac Crossno, Colleyville, TX (US); Ravi Kumar Viswaraju, The Colony, TX (US)

(72) Inventors: Adam Thomas Crossno, Argyle, TX (US); John Mac Crossno, Colleyville, TX (US); Ravi Kumar Viswaraju, The Colony, TX (US)

(21) Appl. No.: 15/871,401

(22) Filed: Jan. 15, 2018

(51) Int. Cl. G06F 16/45; G06N 20/00

(52) U.S. Cl. CPC G06F 16/45; G06N 20/00

(57) ABSTRACT

The present invention discloses novel techniques to enable dynamic screening and manipulation of digital content according to preferences of the user. The user defines parameters that will be used to dynamically analyze and modify the digital content to which they are exposed, while also offering digital media providers an opportunity to insert content that may be desirable given the user's defined preference. The invention also discloses methods for digital media providers to control the display of their content based on analysis of the surrounding digital media in light of their own preferences or in combination with the preferences of users accessing that media.

### FIELD OF THE INVENTION

The present invention relates generally to methods of dynamically screening and injecting digital media according to the specific preferences of various users. Further, the invention overcomes limitations imposed by prior art to provide users highly granular control to dynamically screen and inject digital media content from any number of digital media sources using machine learning and automated analysis tools that minimize negative impacts to the user experience.

### BACKGROUND

A large majority of individuals have access to mobile devices that allow them to remain connected to digital media on a near continuous basis. From smartphones to tablets, PCs, the emergence of virtual and augmented reality, and the increasing variety of electronic devices available to consumers and businesses—continuous connectivity and access to various forms of digital media are becoming expected and somewhat necessary to be a productive member of today's society. Users are becoming more sophisticated in their media access, and media providers are also becoming more strategic about the methods and content presented to their users. Because of this pervasive connectivity, new trends for how digital media is consumed are emerging at a rapid pace. A user is no longer required to watch television or listen to the radio to receive news in real time—nearly every source of media in written, visual, verbal and/or video form is available for consumption when the user desires via online sources that enable on-demand access to digital media content.

Not only is the ability to access media in an on-demand basis now a reality, a number of online media sources have become popular for aggregating media content online to enable the consumer with “one-stop-shop” type of access to media (note the popularity of media and news aggregators like Drudge Report, Yahoo News, Daily Mail, etc.). Furthermore, users are becoming disintermediated from content providers, and in many cases content is being generated by the user base themselves. Note the emergence of social media as an increasingly-used resource for news on current events. In many situations individual users no longer rely on proven and credentialed sources for their news, viewpoints and media access—instead they rely on the members of their social networks and various online sources. In many cases these sources offer questionable, misleading or outright false information. In the case of media forums and blogs (such as Reddit, etc.) there is virtually no way to distinguish good information from bad.

Content from this huge variety of sources bombards the user with so much input that it can become nearly impossible to distinguish legitimate from fake content. Perhaps even more concerning is that in these situations, the user is often exposed to content that has nothing to do with their specific preferences or reasons for visiting a given website or digital media resource. Because a wide variety of content and topics may be aggregated on a single webpage, the user must read through brief summaries of the content in order to determine if they desire to learn more—but the process of briefing the content often exposes the user to unwanted ideas, thoughts or headlines. For example, the simple act of reading through news story headlines can expose the user to a huge amount of negative and depressing content, ideas and topics—many of which the user had no desire to expose themselves to and yet experienced by virtue of attempting to find desired content. This problem is magnified by the tendency of media sources to focus on disturbing, salacious and/or titillating news topics that often drift toward negativity.

Moreover, media providers are increasingly in the position of being able to control the perceptions of the digital viewing public simply based upon which stories, topics and ideas they choose to present. For example, during the recent US presidential election cycle, many traditional and social media firms were accused of intentionally promoting politically-biased content in support of one political ideology or another. The combination of the extreme proliferation of digital media content available, new sources with perhaps questionable authors, opportunities for legitimate sources to highlight and promote content that is biased in some way, and the ability to access this content via multiple digital media devices on a 24/7/365 continuous basis, yields many factors that contribute to the loss of autonomy and control over one's exposure to digital media. These compounding factors risk influencing a user's overall attitude in ways that may not be readily apparent or consciously controlled, contributing to the possible erosion of mood and general outlook on life.

The current state of media presents clear dangers to the user, but it also impacts the media provider as well. As mentioned there are numerous websites that specialize in aggregating content that yields an unpredictable mix of topics, entities, media types and subject matter. Furthermore, the rapidly proliferating trend of user-generated content means that the entities hosting media presentation platforms and publishing media may have limited or even no control over the actual content being posted. Combined this situation with the fact that most websites rely on advertising as a source of revenue, this creates a perfect storm where advertisements can be delivered in proximity to aggregated or user-generated content that the advertiser/media provider may find objectionable. An advertiser may be providing advertisements to a well-respected website, but often that advertiser has no control over when, how and to whom the advertisement is delivered. This problem is exacerbated when the advertiser is further removed from the website via brokers or service providers (such as ad exchanges, ad networks, supply side platforms, and so forth) that specialize in delivering ads in bulk. In these scenarios, the advertiser may have no knowledge or control over the presentation of their media. This presents clear risks of brands being associated with objectionable content and thus having their reputations damaged in the process. The media provider, as well as all other actors in the chain of media creation, delivery and consumption, are at risk.

With a rapidly increasing percentage of the public getting their news from digital media sources, the potential for negative and harmful user repercussions is ever increasing. Media providers are exposed to the same risks, and thus there exists a need for both users and media providers to be able to control and screen digital media content. Those needs form the basis for the current invention.

There are a variety of common methods available to users to filter digital content. One such group of methods involves blocking access to content that has been pre-defined and pre-categorized. These methods typically involve selecting content that the user desires to be blocked, and if a user then attempts to access such content they are not allowed. This method of content blocking is popular for users that want to avoid all content on a category or class of media. For example, when it comes to internet browsing, if a user desires to block access to adult websites for their young child, the child will not be allowed to visit any sites classified as containing adult content. Although this method is effective for complete content restriction, it has undesirable limitations. For instance, such methods typically block access to an entire website even if there is content on that site that may not be undesirable to the user. They also cease to function as desired if a given website is not properly categorized. Additionally, the granularity of options available to block specific content is typically limited in nature because the categories are pre-defined.

A second method of content blocking involves restricting access or display of certain types of files. For example, many current web browsers allow the user to automatically block specific files that may exist on a website as an additional layer of security protection against undesired or potentially harmful content—a popular version of which is to block Adobe Flash files due to their potential for carrying harmful software code that may contain software viruses. Such techniques may also fall into the category of ad blockers, which prevent certain files from displaying when a user visits a site. This method of content blocking does not account for the nature of content contained in the file, it simply blocks all content of a certain file type, which again limits granularity and ability to adapt to the differing needs of the user.

A third method of content blocking uses keywords that are entered by the user. In this case the user can define the content they want excluded, however this type of blocking is usually limited in use to specific websites that natively support the feature. Facebook and Twitter are examples of companies that offer content filters that can be applied to specific content or areas within their sites. Although these filters provide the user with a dynamic and granular ability to filter unwanted content, they unfortunately do not work outside of the native website for which they were intended, and thus only protect the user from undesirable content on the specific website for which they were designed. They are also typically limited in capability to text-based filtering and may not capture undesired content that exists in visual and/or audio-type media.

Methods for allowing media providers (including advertisers, brand owners, marketers, publishers, media creators, media aggregators, and other parties that may otherwise be involved in the creation, distribution, consumption or sale of media) to control how, when and under what circumstances their media is displayed are extremely limited with even less options than are available to users. Services are available that will allow a publisher to restrict certain types of ads from being displayed based on their content as compared to pre-defined categories, however these are typically defined from the publisher's perspective (meaning the publisher/website owner must categorize “good” ads from “bad” and then any ads are filtered as good or bad). This type of filtering and characterization can be effective for blocking entire categories of content, however it lacks any ability to understand the content or subject matter of the website in context of the advertisement itself. Furthermore it does nothing to control the media displayed in light of the preferences of the user accessing the media.

Although there are derivations of the above along with other methods of content filtering, there are no currently available methods for creating holistic digital media screening that works across a wide range of digital content and sites that can be applied based on user preferences, media provider preferences, or a combination of both. The current invention is intended to overcome the limitations imposed by existing digital content filtering methods to provide the user and media provider with a highly dynamic, granular and holistic solution that can be used across all the media types and applications they experience.

### SUMMARY

The present invention utilizes novel techniques to enable screening of digital content in a manner that preserves the typical user experience as much as possible. A typical user is already familiar with the behavior of digital content, the various digital media sources they utilize, and websites used to browse and access such content. Thus the current invention contemplates methods to preserve user expectations of the digital media content access process while enabling greater levels of control in exposure to and delivery of desired and undesired content. The invention also discloses methods for digital media providers to control the display of their content based on analysis of the surrounding digital media in light of their own preferences or in combination with the preferences of users accessing that media. In a disclosed embodiment, an example is detailed in terms of a user using an internet web browser to browse content on a website wherein the browser's function is modified by the current invention—however it should be noted that the invention can be practiced in any scenario where a user is attempting to access digital media via any type of device, software or user interface.

Although portions of the disclosure below focus on an embodiment using HTML and browser-based interfaces, it should be apparent to one skilled in the art that the current invention can be practiced using any combination of digital files, scripts (including JavaScript and the like), browser functionality, applets, databases, links, video, text, sound, other media, user display and user interaction technologies alone or in combination and should not be limited to HTML-based systems. It should be understood that the user can practice the current invention using any type of digital media access including but not limited to web browsing via desktop, laptop, mobile device, cable box, digital assistant (i.e. Apple Siri, Google Digital Assistant, Amazon Alexa, and so forth), robotic interface, virtual reality interface, augmented reality interface, touch interface, gesture recognition interface, radio, wireless, smart appliance, gaming console, voice recognition, brain wave interface, man/machine interface, and/or any other system or method for accessing digital media.

### BRIEF DESCRIPTION OF THE DRAWINGS

For a more complete understanding of one or more embodiments of the present invention and the advantages thereof, reference is now made to the following descriptions taken in conjunction with the accompanying drawings, in which:

FIG. 1 is a block diagram illustrative of the steps involved in screening digital media content; and

FIG. 2 is an illustration of the architecture involved in implementing the dynamic screening of digital media content for a user browsing the internet using a “Server Side” implementation; and

FIG. 3 is an illustration of the architecture involved in implementing the dynamic screening of digital media content for a user browsing the internet using a “Client Side” implementation; and

FIG. 4 is an illustration of the architecture involved in implementing the dynamic screening of digital media content using a “Distributed” system architecture; and

FIG. 5 is an example of a user interface for inputting initial screening parameters and reviewing system-generated derived screening parameters; and

FIG. 6 is an example of the visual display in an internet browser using the invention.

### DETAILED DESCRIPTION

While the present invention may be executed in many different formats for different situations, one embodiment of the present invention is described herein using a web browser plug-in to screen and modify HTML content as the user browses a website. While many different types of technologies, files and code structures are used in digital media construction, formatting and presentation, the invention as described herein will, for discussion purposes, utilize HTML and traditional website browsing as the foundation of application for the disclosed embodiment. Furthermore, while the disclosed embodiments refer primarily to restricting, removing or otherwise screening undesired content—it should be understood that the invention is also intended to enable allowance, addition and/or exposure of desired content as well.

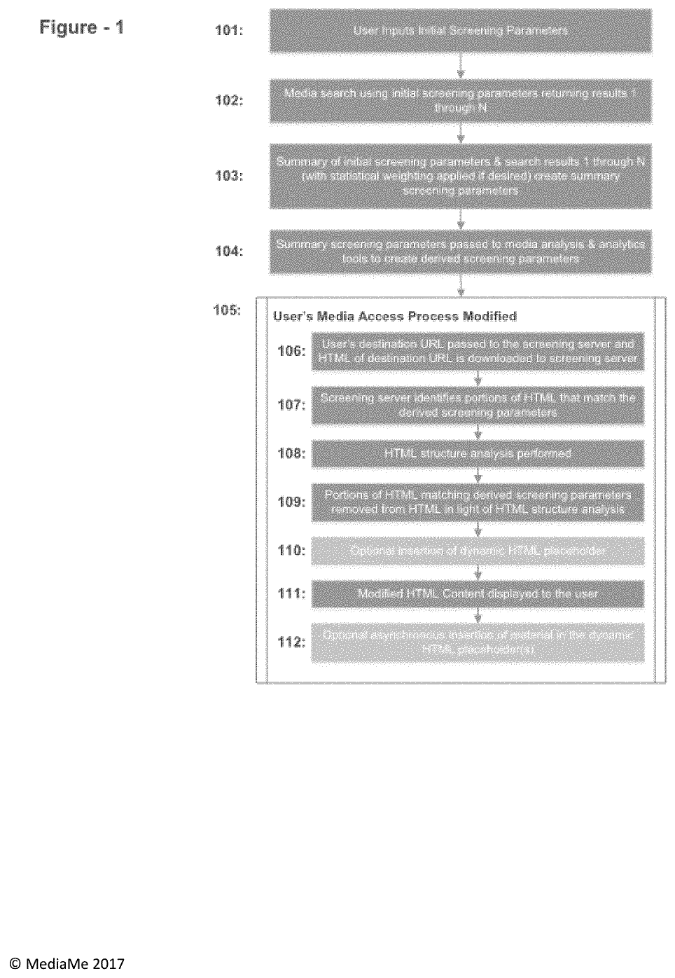

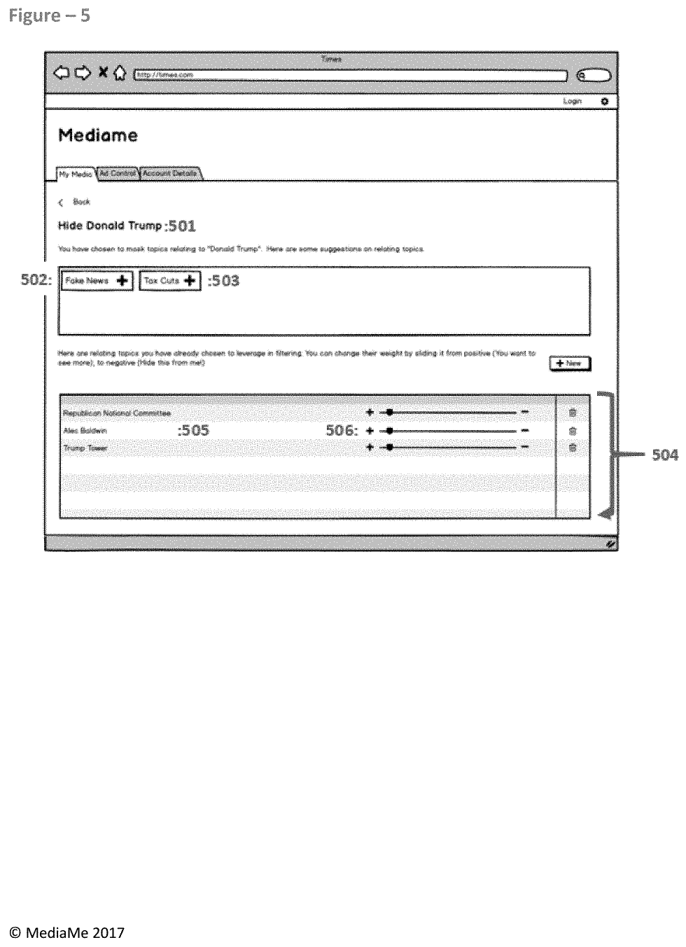

Referring to FIG. 1, Step 101 is the inputting of initial screening parameters that the user desires to restrict from the media to which they are exposed. This can be accomplished in multiple ways, ranging from identification of simple keywords and phrases of undesired content such as “murder” or “child abuse”, or may alternately be accomplished via the user identifying content they encounter (for example by highlighting specific text, images, audio, video or any type of media and identifying the highlighted items as undesired through a menu or right mouse click selection type of process). Creation of initial screening parameters can happen manually, automatically, or determined via profiles of the user that may exist through other means (i.e. the user's Facebook, Instagram, LinkedIn or any other social media and/or social platform profiles could be used to help configure the user's initial screening parameters). One example of such manual input methods can be found in FIG. 5. In this example, in item 501 the user has identified “Donald Trump” as something to hide (i.e. to screen and remove from the web browsing experience). The inputting of initial screening parameters may also be accomplished through touchscreen, gesture recognition, voice commands, visual selection, virtual reality, augmented reality, mind-machine interface, and any other possible method of user interface that provides an avenue for a user to identify undesired media to the screening system.

Step 102 uses the initial screening parameters collected from Step 101 to perform a media search using methods that are already well known in the art (i.e. “Googling”, “Google search” and/or using a media search tool to fetch content related to the initial screening parameters). The media search results can be controlled in terms of quantity, timeframe, general or exact matching criteria and so forth as is well known in the art. The results returned can be a collection of various websites and media including for example URLs (Uniform Resource Locator—commonly informally termed a web address is a reference to a web resource that specifies its location on a computer), pictures, videos, news, books, and various other forms of digital media that correspond to the initial screening parameters that were input. In other embodiments, such content searches may well return other parameters and types of digital media, and the current invention should be construed in a manner to include such methods. In a disclosed embodiment, a given portion of the results most closely matching the initial screening parameters (for example the top 10 results, which many contain links to other websites along with various types of media and media files) would be used. It should be noted that the search may also return media related to the initial screening parameters that are not delivered in the form of URLs, pictures, videos, news, books, etc., rather the results may be digital files or interface instructions (for example, the results may be a pixel distribution analysis algorithm that can be used to identify images of a certain type or category, or the results may be a list of application programming interface methods used to access 3^{rd} party services). The invention also contemplates a media search that returns results directly related to the initial screening parameters, and/or results that may link to other sources that can be used to further analyze the initial screening parameters. One such example would be returning results to various APIs (application programming interfaces) that can be used to leverage additional functionality provided by a 3rd party system—such as using IBM's Watson analytics, Microsoft Azure Cognitive Services, and so forth to access data and/or services that can further help the invention understand the topics, entities, associations and so forth that are related to the initial screening parameters.

Step 103 creates a summary of the initial screening parameters and the search results returned in Step 102. The purpose of performing step 102 and combining the results with the initial screening parameters gathered in Step 101, is to expand the initial screening parameters to identify as much related content as possible to ensure that not only are the initial screening parameters captured, but that additional screening parameters have been identified that correspond to additional content the user is likely to also consider undesirable. In this manner the current invention greatly improves on prior art filtering techniques that do not consider inter-relation of initial screening parameters to other related parameters, media, media types and so on. These additional screening parameters can be provided to any combination of server, database, or cloud-based environment such that the additional screening parameters can be used for additional machine learning, database-building, or otherwise leveraged in iterative processes to further enhance the screening parameters. It may also be noted that one skilled in the art could apply statistical weighting techniques to the results returned in Step 102 versus the initial screening parameters gathered in Step 101 (meaning that it may be desirable to provide more weight to the initial screening parameters versus the search results so that the user's initial screening parameters are given some level of preference against the results from Step 102 that ultimately govern what is displayed in Step 111 as further detailed below). For example each of the parameters input directly from the user may be given a weighting of 1, and each parameter derived as a result of step 102 may be given 0.5 weighting—thus the system can apply more priority to screening parameters directly entered by the user versus the additional parameters derived by the system in Steps 102 and 103. The system may also apply different weighting or additional weighting based on sources of data. For example, results returning from a Google search may be considered more “trusted” versus results retuned from a search on Facebook or social media sites, thus a Google result may have an additional weighting of 1 applied whereas a Facebook result may have an additional weighting of 0.75 applied. The results of Step 103, which combine a summary of initial screening parameters with the search results from Step 102, including any iterative analysis and statistical weighting applied, are termed the summarized screening parameters.

Step 104 passes the summarized screening parameters to various media analysis tools to transform those summarized screening parameters into derived screening parameters. The derived screening parameters are the resultant output of various types of analysis and analytics performed on the summarized screening parameters including but not limited to keyword identification, entity identification, topic identification, sentiment analysis, image recognition, voice to text conversion, voice recognition, machine learning and so forth. Many tools are offered by the likes of Google, IBM, Microsoft and many others that allow a user to input media in the form of text, URLs, files and so forth in order to have the mentioned analysis and analytics performed and presented in a summary file or file types. These types of services can thus allow voluminous data to be distilled into core concepts, keywords, entities, sentiments, node-based entities, hierarchies and various other types of analysis that may be beneficial to distill a large amount of input data into its core constituents. In this manner the current invention leverages such capabilities already known to one skilled in the art to transform the summarized screening parameters into derived screening parameters that are appropriate to use in order to dynamically screen digital media content. Thus the derived screening parameters can now be considered a holistic distillation of user preferences that leverage a huge variety of media sources and analysis tools to provide the current invention with a broad and novel perspective on the preferences of a given user with regards to the content to which they wish to be exposed. The layers of capture, summary, analysis, and distillation that occur through Steps 101, 102, 103 and 104 effectively broaden the understanding of the user's desired content exposure parameters to ensure the current invention can interpret the user's intentions in the most holistic manner possible while accounting for all the various sources and types of media that may be related to the user's initial screening parameters. Additionally, Step 104 captures a host of potentially indirect yet related attributes that provide the invention higher likelihood of identifying content that has simply been re-worded or slightly altered, but yet still relates to the user's initial screening parameters. Referring to FIG. 5, items 502 and 503 are presented to the user as derived screening parameters the system has created based on steps 102 through 104. In one embodiment, the user is given the option to add derived screening parameters 502 and 503 to the system, however inclusion can also be automatic and require no user selection. Item 504 is a listing of derived screening parameters the user has already selected. Item 504 also identifies a novel capability of the system shown in items 505 and 506. Item 506 is a derived screening parameter where the system has identified “Alec Baldwin” as related to initial screening parameter Donald Trump. Furthermore item 506 provides the user control over the sentiment (positivity or negativity) of content matching Alec Baldwin. Alec Baldwin is known for lampooning Donald Trump with an unflattering impression, thus if the user was a fan of Donald Trump they may not like Alec Baldwin and would desire to screen content with positive mentions of Alec Baldwin from their browsing experience. Alternately, a user that dislikes Donald Trump may desire to see content wherein Alec Baldwin is presented with positive sentiment. Item 506 offers the user a slider-type feature wherein they can control how the system applies screening according to the sentiment of the parameter on a sliding scale. One skilled in the art will appreciate this novel capability of the invention. It should be noted that the current invention contemplates using both current and future machine learning and artificial intelligence capabilities to enable the user to input the least amount of initial screening parameters while relying on the invention to use many resources to ensure all derivatives, embodiments and sentiments of the desired and/or undesired content are captured in the derived screening parameters. Although one embodiment of the current invention uses machine learning sources to provide high volume and high throughput capabilities, the current invention can also be practiced by following the disclosed process and using any range of manual or automatic methods of accomplishing the same.

In Step 105, the invention uses the derived screening parameters of Step 104 to dynamically modify the user's media access experience. Such a user experience can be accomplished by the invention modifying the behavior of the user's media access tool (for purposes of this example a web browser) in a substantially unseen fashion (i.e. without the user's direct knowledge) or more preferably via a user-acknowledged function or feature such a web browser plug-in. Most current generation websites and browsers use HTML in order to analyze, process and display media content. Because HTML, software scripting languages and scripts are widely used, this disclosure will detail an embodiment of the current invention assuming it is applied as a plug-in to a common web browser using these technologies, however one skilled in the art will realize that the invention can be practiced using a wide variety of media access and display tools in combination with any number of digital media files, file types and formats. In an embodiment where the invention is accessed via a web browser plug-in, the user will be readily aware of the presence of the invention and can selectively enable and disable its features. Assuming the user has already input the initial screening parameters as explained in Step 101 and shown in FIG. 5 as item 501, and the invention has already used steps 102, 103 and 104 to generate the derived screening parameters as shown in FIG. 5 as items 502, 503, and 504, Steps 106 through 110 will detail how the media screening process is implemented.

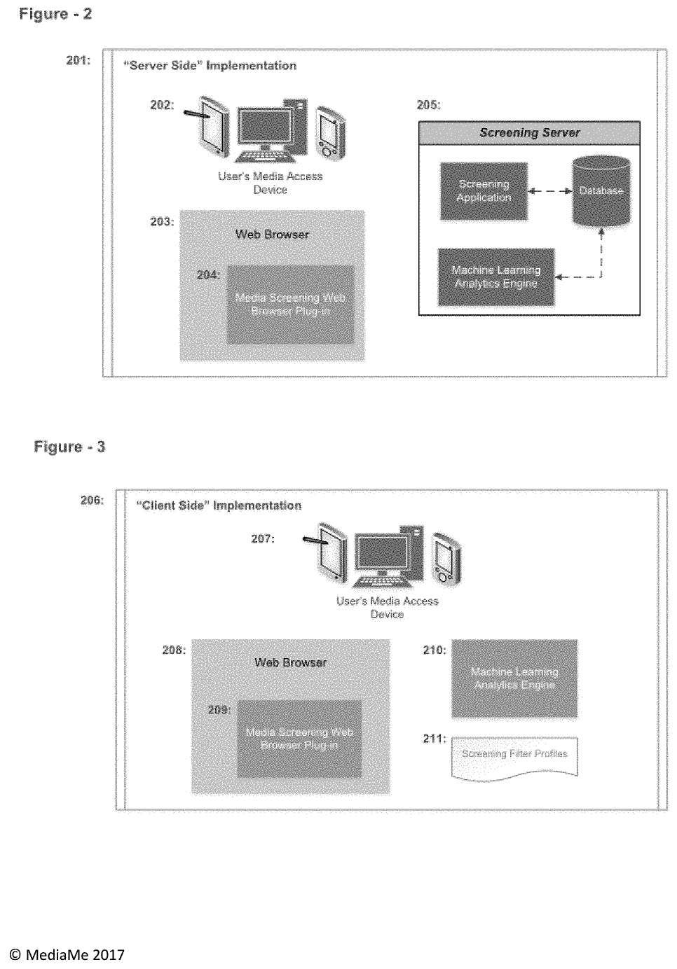

In step 106, the media browser plugin is detecting the destination URL (i.e. web page the user is trying to visit) and that URL is being passed as a parameter to the screening server shown in FIG. 2 as item 205. A screening server can by one or more servers, databases, cloud-based systems, distributed processing systems and so forth. In a traditional web browsing experience, the web browser will simply display the HTML content of the destination URL for the user, but the current invention will instead intercept and download the HTML content of the destination URL and begin the process of analyzing the HTML content for matches against the derived screening parameters prior to displaying anything to the user. The screening server 205 then performs a search of all metrics contained in the derived screening parameters against the HTML of the destination URL to determine if any matches exist. It should be noted that matches can be determined based upon simple keyword searching as well as a more complex analysis of media contained within the HTML. For example, if the HTML contains links to a visual media file like a picture or video—the server can download the file for comparison against the attributes defined in the derived screening parameters. Pictures can be analyzed by a number of methods including pixel analysis and machine learning to derive subject matter, entity identification, description of what is depicted in the picture, identification of entities shown in the picture, detection and translation of text, facial analysis and so on as known by one skilled in the art. In a similar fashion audio files can be converted to text via speech recognition tools for additional methods of analysis and determination of matching to the derived screening parameters. The ability to analyze many forms of digital media beyond simple text analysis forms an import capability and differentiation of the current invention beyond traditional media filtering techniques. As a result of the breadth of analysis that can be performed on all types of media included in the HTML content of the destination URL, one skilled in the art will appreciate the processing power required to determine if any HTML content, inclusive of content actually contained in the HTML itself and/or content linked from the HTML, matches the derived screening parameters.

Because many current generation websites can be considered content aggregators (i.e. sites that link to content from multiple other websites to allow the user to review and access a large amount of media that may not be directly stored or controlled by any single entity), the current invention contemplates a recursive process that can be used to ensure digital media content is thoroughly evaluated against the derived screening parameters. As an example assume the user is attempting to view the website Yahoo.com. This website contains a large amount of aggregated content including text articles, visual media, audio media and so forth all linked from a single web page the user can scroll through. As the current invention downloads the HTML of Yahoo.com and begins the process of determining matches to the derived screening parameters, the first method used is a general text analysis of matches to keywords and phrases contained in the derived screening parameters. This process will identify any portions of the HTML that require further analysis. As mentioned above, various statistical and mathematical weighting parameters can be applied to this analysis. For example, assume the user has indicated a desire to remove any media related to the “the Holocaust” from their web browsing. The invention may be searching the HTML of the destination URL for reference to “the Holocaust”, and the derived screening parameters may have identified “Germany”, “concentration camps”, and “Adolf Hitler” as related. As the invention screens the HTML content it may detect “Germany” included in the headline of an article, however none of the other terms are contained. In this instance, the pure mention of “Germany” without the corresponding terms of “the Holocaust”, “concentration camps”, and “Adolf Hitler” may indicate content that should pass through the screening process and be displayed to the user. As one skilled in the art can appreciate, various mathematical and statistical methods can be applied to the derived screening parameters to require certain inter-relation, recurrence, and/or linking of parameters to occur in order to cause the invention to remove and/or modify the content for the user (i.e. at least of one of “the Holocaust”, “concentration camps”, or “Adolf Hitler” must occur in the portion of HTML content along with “Germany” to trigger removal of said content).

Continuing with the example above, it may occur that the word “Germany” is detected in the HTML along with a link to a secondary URL, yet there are only a few additional words in said portion of the HTML containing “Germany”, none of which are contained in the derived screening parameters. In this scenario, it may be difficult to determine if this mention of “Germany” is related to “the Holocaust” because the system only has a few words or single phrase to evaluate. Thus, it may be desirable for the system to download the HTML of the secondary URL to further analyze the content and determine if a match to the derived screening parameters exists. This type of layered approach presents obvious benefits to prior art filtering, especially considering the trend that many websites regularly link to external content in some way. As one skilled in the art will appreciate, the layered ability for analysis of the destination URL, secondary linking URLs, and even perhaps tertiary or more linking URLs, includes many benefits yet also increases the processing load of applying the media screening service for the user. Especially when the media is more than text analysis of HTML content and begins to include image, video and/or audio content, the processing effort can become large and be difficult to perform quickly in a manner that does not impact the user's browsing experience. Thus in certain situations it may be very difficult to fully conclude the process of screening all content, including linking content, of the destination URL without creating unwanted delays in the user experience. In such situations, the invention adds the novel concept of using a Dynamic HTML Placeholder. One skilled in the art will be familiar with the concept of HTML placeholders. In many situations such objects are used to deliver advertisements that may come in the form of text, images, audio or videos that are selected based on the preferences and/or browsing history of the user. The advertising content is usually delivered from a 3^{rd} party based on the mentioned user profiles and/or history. In many scenarios this results in unwanted performance delays in viewing a website because it waits to render on the user's screen until the advertising material has been loaded. In situations where the web page attempts to display content before advertisements are completely loaded, it can result in blank spaces or content on the web page moving around as the user is browsing and advertisements continue to load. In these cases, such impacts to the user experience is caused by delays in querying 3^{rd} party systems for the advertising content and those systems delivering the content back. That is to say the resultant content delivery delays are purely the result of pre-defined secondary processing tasks versus the truly dynamic processing tasks that are disclosed as related to analysis of secondary, tertiary or more URLs and associated media. Thus, the current invention contemplates a novel process and purpose behind the need for a Dynamic Placeholder (which may or may not be an HTML or script-based object) to deliver content back to the user in an asynchronous manner.

In Step 107, the screening server, servers, user access device or a combination of all, identifies the portions of HTML that contain matches to the derived screening parameters (noting that said portions containing matches to the derived screening parameters may exist in the primary, secondary, tertiary or more HTML portions in both the destination URL and URLs linked from the destination URL as described above).

In Step 108, the system performs an analysis of the media structure (in this example HTML) to determine how the structure can be modified to remove the undesired content that matches the derived screening parameters. The purpose of this analysis is to determine how such matching portions can be removed from the media in a manner that minimizes impacts to the user experience. At a minimum such removal should not cause the media itself to cease functioning or become non-displayable to the user. Ideally, such removal would not impact the user experience at all and be indistinguishable from the experience associated with user interaction with the unmodified media. In the disclosed embodiment, once portion(s) of the HTML that match the derived screening parameters has been identified, the invention performs an analysis of the HTML to determine structure and formatting for the purposes of removing said matching HTML portions in a manner that does negatively impact the user experience or the content formatting of the HTML for the destination URL. One skilled in the art will understand the concept of HTML tags, and how such tags are used to control and govern the structure and display parameters of HTML code.

The goal of the system, when construed against the HTML example disclosed, is to analyze the HTML tag structure of the content matching the derived screening parameters and identify exactly what portions of HTML should be removed to ensure the matching content is not displayed to the user while avoiding issues where the HTML does not display and perform in a substantially similar manner to the unmodified HTML. It should be understood that seamless browsing may not be possible in all scenarios, and that blank spaces or other formatting flaws can occur. Although the intent of the system is to minimize formatting and display flaws, one skilled in the art can understand that media type and formatting varies widely and thus the invention can still be practiced even in situations where the media must be substantially modified to remove undesired content in a manner that negatively impacts the user's media access and/or browsing experience. Referring again to the HTML example, one skilled in the art also understands that it may be difficult to simply remove content and/or attributes from inside a given HTML tag that contains matching content. The invention must also check for well-formed HTML tag syntax across the entire HTML code of the destination URL to appropriately understand the HTML tag hierarchy for the purposes of identifying which matching portions can be removed to achieve the purpose of removing undesired content while preserving the user experience.

In Step 109 the system removes the undesired content from the media and creates a Modified Media Content. In the disclosed embodiment, the Modified Media Content would be modified HTML content, which is the result of removal of portions of the original HTML of the destination URL that match the derived screening parameters in light of the media structure analysis described above. The Modified Media Content may simply be altered HTML (the modified HTML content) that is delivered to the web browser, or it may be any type of file, script, object, executable instruction or media that can be displayed and/or presented to the user via any means. For example, the Modified Media Content may be an image where portions have been redacted or altered according to the screening process disclosed. Likewise, the Modified Media Content can be any type of visual, auditory or other media that has been modified, removed, redacted or otherwise altered according to the purposes of the system.

In optional Step 110, the invention inserts new media in place of the media removed in Step 109. The new media may be simple text(s), image(s), video(s), URL(s), advertisement(s) or any other type of media that can be delivered to the user. As disclosed above, the new media may be a Dynamic HTML Placeholder. On one hand the Dynamic HTML Placeholder may be populated with simple text(s), image(s), video(s), URL(s), and/or advertisement(s) delivered by 3rd party media providers, and act in manner similar to that known in the prior art. On another hand the Dynamic HTML Placeholder may act in a novel capacity not disclosed in the prior art by serving as placeholder that can be populated at a later time even after the Modified HTML Content has been displayed for the user. As one skilled in the art can appreciate based on this disclosure, the time lag between the user inputting the desired destination URL and the creation of the Modified Media Content may be significant in situations where secondary, tertiary and more URLs and associated HTML code must be analyzed to determine matches against the derived screening parameters. Thus, the invention contemplates displaying Modified Media Content for the user using Dynamic HTML Placeholders for portions of the content where the invention is still undergoing analysis. In this situation, as shown in optional step 112, the invention may well determine that portions of HTML content of the destination URL that were initially flagged as potentially matching the derived screening parameters has been subsequently determined to be non-matching after secondary, tertiary and more analysis has been completed on linking URLs. As a result of ultimate determination of non-matching, the invention may re-insert portions of the original HTML into the Modified Media Content using the Dynamic HTML Placeholder. The user may experience a blank space or other indication of continued processing of media when the media is initially displayed, and the media may be injected in said space at a later time. Ideally such time differential would be minimal, and the user may be given an option to control this feature to some extent. For example, the user may set a maximum “analysis timeout” feature to 3 seconds whereby the Modified Media Content is displayed to them in no more than 3 seconds after inputting their destination URL whereby the Dynamic HTML Placeholder is not used and the user accepts the risk that certain media may be removed based purely on initial screening analysis without the benefit of secondary or more analysis. Thus the user can be placed in control of certain aspects of their experience with the invention, and the Dynamic HTML Placeholder may or may not be used as a result.

It should also be noted that the invention can be practiced using different architectures where the primary media screening is performed on a secondary server (“server side” option 201 as illustrated in FIG. 2) or on the user's device (“client side” option 206 as illustrated in FIG. 3) or any combination thereof. As one skilled in the art will appreciate such options and combinations offer a variety of avenues to alter the response time, processing power required, data volume, transaction analysis recording, privacy implications and so forth of the invention. It may also be desirable for the user or system to select between server or client side implementation, or allow the invention to auto-select which implementation is more appropriate based on the user's media access method, device, bandwidth, complexity and/or type of screening desired, and so forth. An example embodiment of the “server side” architecture would include item 205 with a database, server, or cloud-based architecture alone or in combination that maintains user screening parameters, summary screening parameters and derived screening parameters and a web application to screen the content and interact with the browser plug-in setup on the web browser running on the user's media access device. The machine learning engine would create the derived screening parameters from the summary screening parameters. The web browser plugin would be implemented in JavaScript and communicates with the screening server thru Web API over secure HTTP. An example embodiment of the “client side” architecture would include the screening application and the machine learning engine on the client side and the screening parameters profile would be maintained on the client side as well.

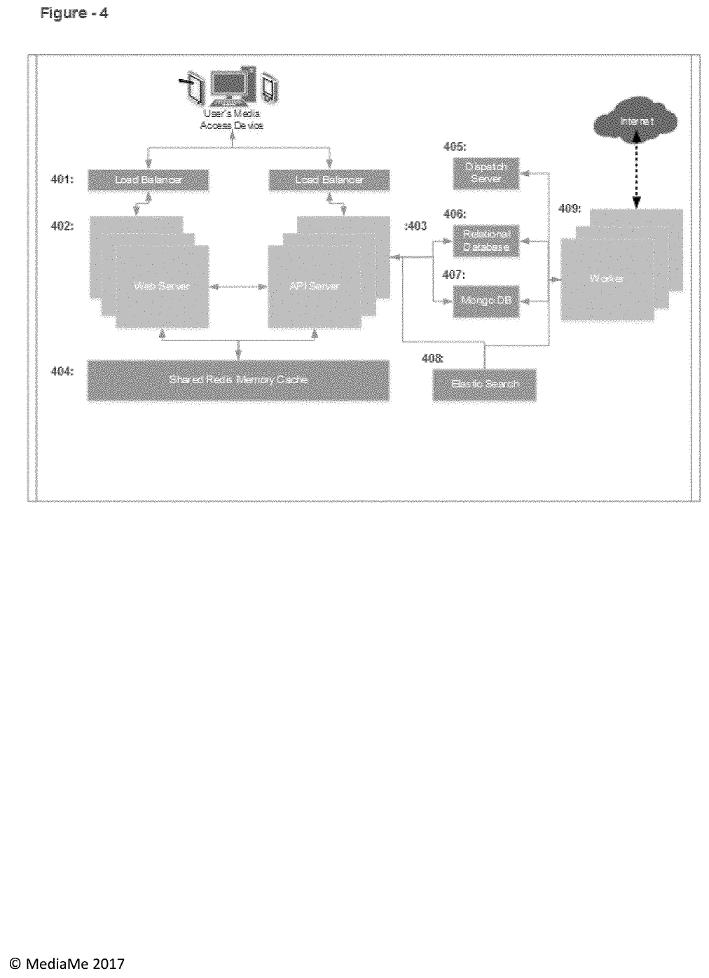

Furthermore, the invention can also be realized using a distributed computing model where portions of the system reside in “cloud” severs, on premise servers, on the media access device of the user, databases, scripts, APIs and so forth. Each system component may be specially configured to perform one or multiple functions of steps 101 through 112. Referring now to FIG. 4, an illustration of a distributed architecture is shown to depict one possible embodiment of the system. Item 402 represents the Web Servers that host the website used to manage the user accounts, and a Web Portal application used by the users for interacting with the system to input screening parameters and interact with the system. Item 403 represents the API servers. All transactions across the system, both within the system and to the outside world, take place through RESTful Application Programming Interfaces (REST APIs) that are well known to those skilled in the art. All clients (including but not limited to Web browsers, mobile apps, third parties, other APIs, etc.) interact with the system via REST APIs which are stored in the API Server. As the number of system users grow, the number of client applications interacting with the system grows as well. As system load increases additional instances of Web Server 402 and API server 403 can be created to cope with demand and preserve quality of service. Item 401 represents the Load Balancers that manage distributing transactions over the available Web Servers and API Servers. When user requests come in to the system, the system stores these requests in a structured database depicted by Item 406. In addition to screening preferences, 406 stores data associated to user accounts, settings etc., and should in general be considered a traditional storage for structured (relational) data. In order to create derived screening parameters from the user's initial screening parameters, a large amount of data (which may in the form of web pages, URLs, text, images, audio and any variety of media as disclosed above) needs to be parsed, processed for context analysis, relation analysis, sentiment analysis, parameter matching and other machine learning operations. These data processing operations demand significant resources and parallel tasks represented as “workers” shown in Item 409. Each worker may perform a task, a portion of a task, or a processing operation as required by the system. Because of the nature of the system and its use, many of the operations performed and data encountered are highly variable and may lack a detailed structure. Therefore Item 407 represents a Mongo DB (a No SQL database that helps store large unstructured datasets). It should be noted that the system could make use of any database (structured, unstructured, or a combination of both) without regard to specific brand names or providers. The data stored in Item 407 will allow the system to find patterns between content and derive suggestions for additional screening parameters that may be of interest to the user. Mongo DB does an excellent job of storing and retrieving unstructured data, but it has a poor performance when it comes to large-scale text indexing. In order to provide the best user experience and system response time, Item 408 Elastic Search is used. Elastic Search is a powerful searching and indexing algorithm that allows the system to run fuzzy text searches on large quantities of unstructured data efficiently and quickly. Because optimization is key for overall system performance, Item 404 Shared Redis Memory Cache is used. This allows all Web and API servers to process requests and leverage the same high read memory that supports intensive read operations from the database. If another server recently made the same request, it shares those results with the other servers through the Memory Cache instead of incurring redundant unnecessary requests to the database. Item 405 represents a Dispatch Server that watches the database and combs through known website URLs when processing user screening parameter requests. It assigns Workers, Item 409, to process information. It monitors progress and reassigns work as needed. The dispatch server ensures the system is processing data effectively and in order of priority. Although specific products and roles have been mentioned in relation to the embodiment disclosed in FIG. 4, it should be noted that any system architecture offering similar features may be utilized in any combination of the above, or in combination with the “Sever Side” and “Client Side” embodiments shown in FIGS. 2 and 3.

In Step 111, the Modified Media Content (i.e. the modified HTML content in the disclosed embodiment) is displayed on the user's media access tool. The Modified Media Content may or may not include a dynamic placeholder (i.e. Dynamic HTML Placeholder in the disclosed embodiment). Depending on the implementation of the invention, the user may or may not be notified that the original media file has been altered.

Please note that although an embodiment disclosed is based on a media access process according to a typical web browsing experience using a commercially available web browser, the inventors also contemplate the invention being used to screen streaming media content. Content can be pre-screened, screened in real time, or post-screened. A similar process to that described above could be used to alter any variety of streaming media including audio and video, with the possible need to implement a time-delay feature between the user accessing the content and the modified content being provided in order to allow for the processing time required to modify said content according to the user's preferences.

It should also be noted that a user can share the resultant derived screening parameters with another user or users, such that other users may experience media browsing according to another user's preferences. Much like a user can “follow” another user on the social media services such as Facebook or Twitter, the user base or system of the current invention could share their derived screening parameters with one or many others in a process similar to that used for traditional social media information. In this manner, it would be possible for public individuals or groups (i.e. celebrities, political and/or religious figures, groups, organizations, governments, etc.) to allow their followers to experience digital media that is dynamically screened as disclosed in the current invention, thus providing a unique and novel experience to expose oneself to the media perspective, tastes and preferences of others in a way that is not currently possible via any other product or service.

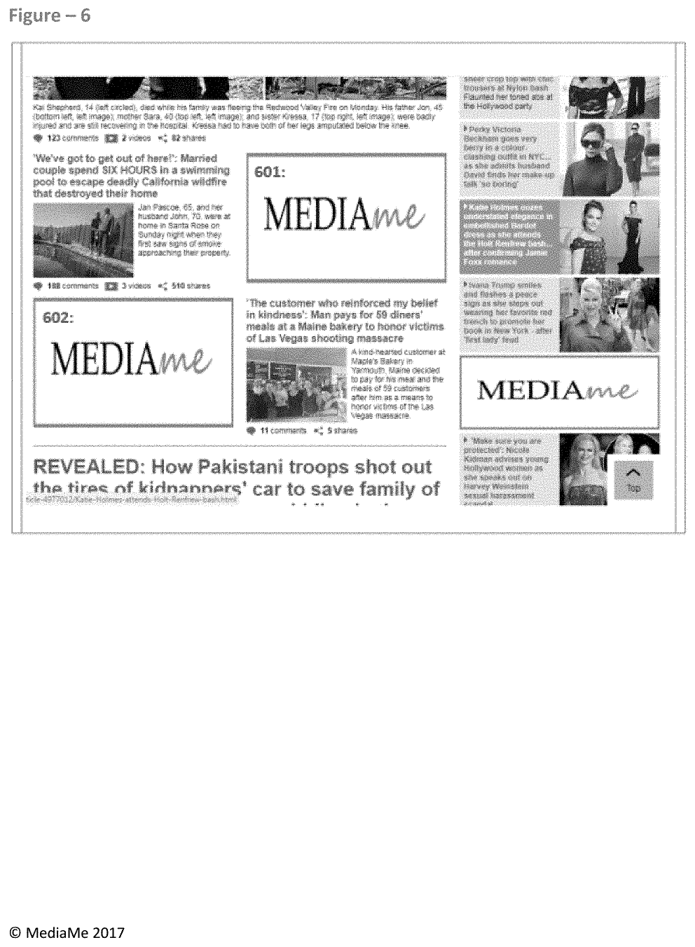

In another embodiment of the invention, any of the features or processes described in steps 101 through 112 can be used and content that has been altered (for example removed) through the steps above can be replaced or modified with new content. Referring now to FIG. 6, the user-interface display shown illustrates a scenario in which the content removed through the process described in steps 101 through 112 creates items 601 and 602 in the form of a placeholder (HTML placeholder, Dynamic HTML Placeholder, frame, text box, plugin, script, or any other web technology that can be used to deliver content) that is displayed in the space previously occupied by content that has been removed according to the methods described. As discussed in steps 101-112, the removal of content can be performed a variety of different ways, and the display of new content in place of content removed can also be accomplished in a variety of ways. In one embodiment shown in FIG. 6, a logo or icon can replace the filtered content such that a branding, advertisement, or other graphic can be displayed. It is within the scope of invention that dynamic advertisements or media that meets the user's criteria can replace the filtered content. That is to say, the invention contemplates inserting new media in the place of media removed or altered through steps 101 through 112.

As illustrated in FIG. 6, this insertion capability can take the form of a product logo in one embodiment shown as items 601 and 602, however it can also be used to inject new media that complies with the preference parameters established by the media provider, the user, or a combination of both. The inventors have contemplated using the same or similar techniques as disclosed in steps 101 through 112 for the benefit of media providers that may desire to deliver new media in the place of media that has been removed using the current invention. As mentioned supra, any new media delivered by a media provider could pass through the screening process described, thus ensuring compliance with the user's established preferences. One skilled in the art will realize the additional benefits of allowing the media provider to also establish preferences that govern when the media provider's content is displayed to a user in light of either the other media surrounding the filtered content, the user's preferences, or a combination of both. In this scenario, any new media delivered to the user would be in compliance with the user's preferences (user screening parameters) and the media provider's preferences (media provider's screening parameters). Thus, the present invention provides unique, novel and clear improvement over prior art systems that do not fully consider the preferences of both users and media providers in context of other media in proximity to the user's view. As discussed, media providers face risk in supplying their media to 3^{rd} parties for insertion as there does not exist today adequate means to protect their media from being displayed in proximity to content the media provider would find undesirable or otherwise likely to harm the user's perception of their media—using the same or similar processes as described in steps 101 through 112 for the media provider (as well as the user is so desired) highlights distinct benefits of the current invention over prior art systems.

In another embodiment, the invention can dynamically create requests for new media from media providers when a placeholder such as 601 or 602 is available. This request can incorporate an advertisement availability notification and specify pricing charged for new media insertion as is common practice in the art today. Uniquely, the system can also add to this request additional parameters such as specifying the type of content requested according to the user's preferences, specifying the type of content requested according to the media provider's preferences or define any combination of various parameters or features that may be desirable to the user, the media provider or both. Being able to bundle metrics associated with user and media provider preferences to such a request, in light of the analysis of surrounding media proximate to the media insertion area, adds new dimensions to the process that are both novel and inherently valuable to all parties in the media supply and deliver chain. Said request can be made in real time, near real time, or may be predictive in nature based on the history, profile and screening parameters of the user and/or media provider. This represents a powerful opportunity for live modification of the space where the screened content was located and allows substitution of various media types and content meeting the screening criteria. Said request could also occur after one or more users has already viewed the content (meaning the system may collect data and perform analysis on one or many users and their associated preferences prior to initiating requests for media insertion in light of historical user activity and preferences). Criteria or parameters the system can use in determining the appropriate media for media insertion includes but is not limited to:
a. User screening parameters (including initial screening parameters, summary screening parameters and derived screening parameters);
b. Media provider screening parameters (including initial screening parameters, summary screening parameters and derived screening parameters);
c. Similar user screening parameters (including initial screening parameters, summary screening parameters and derived screening parameters for users similar to the current user);
d. Similar media provider screening parameters (including initial screening parameters, summary screening parameters and derived screening parameters for media providers similar to the current media provider);
e. User's or media provider's geographic region, location, established geofenced areas, or other geo-spatial parameters;
f. Similar user's or similar media provider's geographic region, location, established geofenced areas, or other geo-spatial parameters;
g. User history (including past media and advertisements the user has clicked on or through);
h. Media provider history (including past media and advertisements created, handled, provided, delivered or otherwise transacted);
i. Similar user history (including past media and advertisements that users similar to current user have clicked on or through);
j. Similar media provider history (including past media and advertisements created, handled, provided or otherwise transacted from media providers similar to the current media provider);
k. Size of the space available for media insertion;
l. Characteristics including color, background color, position, styles, and other attributes of the space and media objects surrounding the space available for media insertion;
m. Analysis of the media determined to be appropriate for insertion in the placeholder (e.g. video, audio, animation, text, graphics and so forth);
n. User content provided during specific time ranges (e.g. last minute, last hour, last week, last month, last year, etc.);
o. Content provided to similar users during specific time ranges (e.g. last minute, last hour, last week, last month, last year, etc.);
p. Media provider content provided during specific time ranges (e.g. last minute, last hour, last week, last month, last year, etc.);
q. Similar media provider content provided during specific time ranges (e.g. last minute, last hour, last week, last month, last year, etc.);
r. Content that is similar in nature to other content displayed on the screened web page (product comparison or competing advertisements);
s. Content based upon machine learning of other similar screened content and the use of predictive analysis to quickly identify appropriate content;
t. Content based upon the type of media preferred by the user and/or media provider;
u. Content based upon multiple portions of screened content and determining a hierarchy for each new item of content to be injected in the two or more screened content locations;
v. Content based upon modeled user and/or media provider preferences in combination with popular content associated with other users and/or media providers with the same or similar preferences;
w. Content based upon recent user sentiment, recent media provider sentiment, unscreened content sentiment, screened content sentiment, or any combination thereof;
x. Content based upon sentiment of all users and/or media providers within a given time period;
y. Content based upon sentiment of all screened content, unscreened content or a combination thereof within a given time period;
z. Content based upon sentiment of current events and/or popular content within a given time period;
aa. Content based upon mood analysis of the user and/or media provider performed by the system;
bb. Content based upon mood analysis of users, similar users, media provider or similar media providers within the same general vicinity;
cc. Content based upon mood analysis of current users of the system, past users of the system or predicted users of the system;
dd. Content based upon system machine learning analysis, benchmarking, ranking and/or hierarchical analysis of current users, past users, predicted users, current media providers, past media providers, predicted media providers or any combination thereof;
ee. Content based upon biometrics of the user (e.g. eye position, pupil dilation, voice inflection, blush response, blood flow, gesture recognition, nervousness, calmness, health status, etc.);
ff. Content based upon biometrics of similar users (e.g. eye position, pupil dilation, voice inflection, blush response, blood flow, gesture recognition, nervousness, calmness, health status, etc.);
gg. Content based upon biometrics of the user (e.g. eye position, pupil dilation, voice inflection, blush response, blood flow, gesture recognition, nervousness, calmness, health status, etc.) in reaction to viewing content;
hh. Content based upon biometrics of similar users (e.g. eye position, pupil dilation, voice inflection, blush response, blood flow, gesture recognition, nervousness, calmness, health status, etc.) in reaction to viewing content;
ii. Content based upon user interaction with the media (e.g. position of finger or mouse, dwell time of finger or mouse, speed of finger actions, force of finger actions, speed of mouse, etc.);
jj. Content based upon similar user interaction with the media (e.g. position of finger or mouse, dwell time of finger or mouse, speed of finger actions, force of finger actions, speed of mouse, etc.);
kk. Content based upon user ethnicity, socio-economic status, gender, sexual preferences, political affiliation, organization memberships, recreational activities, etc.;
ll. Content based upon similar user ethnicity, socio-economic status, gender, sexual preferences, political affiliation, organization memberships, recreational activities, etc.

It should be noted that in one embodiment, the invention can also be used to influence the media content in non-web-based forms of content delivery. Examples of non-web-based content delivery include, but are not limited to: digital ads, digital billboards, radio, virtual reality, augmented reality, mind-machine interface or any other method of delivering content that is not considered “online”, internet enabled or otherwise connected to the world wide web.

As disclosed above a media provider can achieve substantial benefit from using the present invention to control how, when, where and why their media is displayed in light of their own preferences, the user's preferences, or a combination of both. The media provider can also derive additional benefits by using the techniques disclosed to analyze the performance of their media in light of the surrounding media to which the user is exposed while also viewing their media. In such an embodiment, a profile or metrics can be created by the system that includes analysis of the media surrounding an advertisement, entities involved in the content near the advertisement, topics associated with the website, metadata associated with the website, sentiment, click rate statistics for one or more forms of media on the web site, mood analysis of the user, social media data of the user, social media trends related to the web site or media on the website, user reactions related to the content on the web site, or coloring schemes of the webpage. The system can thus understand the context surrounding an advertisement in consideration of said metrics and others, to better understand what combination of metrics yields higher engagement from the user. The system can combine these metrics, perform artificial intelligence analysis, machine learning analysis, user analysis, media provider analysis and any of steps 101 through 112 to create a media profile or wrapper associated with a given advertisement, portion of media or area on the website. Such a media profile or wrapper is termed “Cognitive Media”. The term Cognitive Media indicates that the ad (e.g. a cognitive ad) is capable of intelligent and autonomous analysis of the context in which it is presented to the user. Being able to record, measure, compare and analyze how the user interacts with such cognitive ads across a wide variety of surrounding media provides substantially more depth of user engagement understanding than exists with prior art systems. The media itself (in this example an advertisement) is now conscious of its surroundings, and can offer the media provider statistics on user engagement that can generate substantial business and economic value. It should be understood that the terms “Cognitive Media” and “Cognitive Ad” are substantially interchangeable in so far as they describe types of media that become quasi self-aware using the system of the present invention. As a result, the capabilities are the system are leveraged for the media itself (versus for the user and/or the media provider as mention supra).

One skilled in the art will appreciate that nearly any type of media can be turned into Cognitive Media, and that the system disclosed can be used to generate entirely new media that has cognitive capabilities, or it can be used to equip existing media with cognitive capabilities. The system could also provide such cognitive features through use of an API in order to turn any type of media into Cognitive Media, used in any combination of response times (i.e. in real time, near real time, post time or proactively) based upon the system's capabilities as described above. Once the Cognitive Media is created, various metrics, analytics, and data associated with the Cognitive Media can now be used in combination with the other methods disclosed supra to allow the Cognitive Media to control its own insertion allowance or denial, while also recording various statistics on user engagement with itself in light of surround media.

In another embodiment, this Cognitive Media concept can be combined with the various placeholders made available based on user screened content as detailed above. Such an embodiment would create a “Cognitive Placeholder”, whereby the placeholder space created when content is removed based on user preferences is now capable of self-analysis using the techniques mentioned. Such a Cognitive Placeholder could perform analysis of the media and conditions surrounding itself, and then using that analysis could request specific types of media to fill itself in light of its surroundings and the user's preferences. The Cognitive Placeholder could maintain awareness of user engagement based on the wide variety of parameters disclosed, and could act autonomously to request new/alternate media to inject into itself to enhance user engagement even further. Upon reflection one skilled in the art will appreciate the novel and substantial benefits of this cognitive capability. Now the system can self-analyze surrounding media, combine that analysis with media provider preferences, and further combine that analysis with user preferences to simply record user engagement, or to take actions to enhance user engagement. This Cognitive Placeholder concept can thus screen for the best media to insert into itself that will likely please the user, have a higher likelihood of eliciting a response from the user, and ensure compliance with the media provider's and user's preferences. Such capabilities are both unique and highly valuable to the industry.

The system enables these cognitive components to learn, use analytics, use metrics and use data collected over time to determine how to replace certain screened content automatically. It should be appreciated by one with skill in the art that over time certain screened content can be replaced with content that is best suited for a placeholder based upon the system's capabilities and functions, and the system can become more automated as it “learns” the best combinations of metrics, media parameters and user behavior to extract maximum value from its actions. This type of functionality derives its power through iterations of screening similar or dissimilar content and placing new content while taking into account various parameters such as sentiment, past preferences, location or many other criteria as disclosed above.

In another embodiment, the system is configured to take a snapshot of data when an advertisement that has replaced screened content has been selected or clicked by a user. This snapshot captures metrics related to all media surrounding the advertisement when it was clicked by the user, and can be in the form of parameters, profiles, XML documents, scripts, or other data that is generated by the system. For example, the snapshot is configured to, alone or combination, capture the text around the advertisement, the font type, the color scheme associated with content around the advertisement, sentiment related to the web page, sentiment related to a certain portion of the web page, sentiment related to the selected advertisement, context and content of the media surrounding the selected advertisement, the scroll level of the website or scroll location when the advertisement is selected, or any other data related to the web page or its content when the advertisement is selected. This creates a holistic record of the conditions that existed when the user interacted with the media that can be analyzed, archived, modeled and otherwise data mined to better understand what conditions and combinations of conditions may cause a user to act. In another embodiment, at least a portion of the snapshot is provided to an analytics or machine learning engine for future use in deciding which media or advertisements to use in replacement of screened content. In another embodiment, the system is configured to use data related to advertisement conversion rates to determine or rank which replacement content may be best for certain types of screened content. This is a unique aspect of the invention as metrics associated with advertisements that were not only selected by the user, but also led to converted sales, are of high priority for media providers and advertisers. In another example, this data can be provided to third-parties, advertisers, brokers, APIs, or other systems that allow these entities to further take advantage of the invention's functionalities as described herein. Using these techniques, it would thus be possible to understand the surrounding media conditions that precipitate the user's media engagement, which can then be taken into consideration in order to provide media more likely to be clicked by the user or similar users under certain conditions.

In another embodiment, and in relation to steps 101-112 as well as FIG. 6, the system is configured to provide metrics to advertisers regarding certain topics, products, services, trends, type of advertisements, click through rates, or other metrics such that the system would create pricing for these highly dynamic events in real time or near real time. For example, registered advertisers of the system may be informed by the system that cell phone covers are a hot topic, trend, or receiving a higher than normal click through rate when they are being displayed next to specific articles referencing the latest product launch from Apple. Perhaps the system also indicates that even higher click throughs occur when a cell phone cover advertisement is displayed next to content mentioning the latest product from Apple where the website also mentions Samsung product. The system can then generate availability notices for media insertion opportunities that exist near content referencing Apple's latest product launch with a price of $0.005 per insertion, but provide a price of $0.008 for insertion opportunities that exist near content referencing Apple's latest product launch and mention Samsung. The system can also provide dynamic pricing considering the higher likelihood of ad clicks that will occur as further user engagement patterns are analyzed. Thus, if the previous price for insertions near content mentioning both Apple and Samsung was $0.008, but the system detects click throughs continue to increase over time with this combination, the price may dynamically change to $0.01 per insertion. This provides a unique combination of real time user behavior analysis in context of surrounding media that is likely to drive more media engagement by the user. In most situations advertising is done in bulk and the cost of each ad is very small, however using the current invention the advertiser can have much more confidence the user will be interested in the ad and will be willing to pay more for its insertion. In addition, the system can generate reports to media providers that can help tune their strategies. For example, the system could periodically generate reports that indicate what type of ads are generating more clicks based on which news stories they are displayed alongside—such a report could be sent to the advertising industry to help them develop new advertisements targeted to run next to specific new stories. Then the advertisers may elect to offer a discount for these products now or on a given website with similar characteristics such that there is a better than normal chance of receiving click throughs, sales, or additional interest in a product compared to a traditional advertisement placing process as currently known in the art.

In another embodiment, the system is configured to provide registered advertisers and media providers with an interface, API, or other method to identify content that they 1) never want to be next to or associated with; 2) content they would prefer not to be next to or associated with; 3) content, based upon certain factors such as time, trends, or other metrics, that they would never or prefer not to be associated with; 4) metadata of the webpage or offensive content that they never want to be associated with or have an advertisement associated with; and 5) content that they would prefer to be associated with or always want to be associated with. In this embodiment, the registered advertisers can send to a system API, or enter into a system user interface, its preferences for content to avoid and seek. Optionally the registered advertiser may provide their content preferences to the system in other electronic formats that allow for automated entering, setting or management of these preferences without the need to use a graphical user interface. The system is also configured to provide registered advertisers with numerous contextual analysis metrics, summaries, heat maps for certain web page locations, sentiment, mood analysis or any other data described herein. By providing these metrics, summaries, or suggestions to the advertisers, they may use the data to make informed decisions on whether to modify their preferences, types of advertisements, or the like. In another embodiment, the registered advertisers (registration can be a simple as having joined or logged into the system) are provided the opportunity to select context parameters such as topic, entity, sentiment, trend, social media, click through rate, conversion rate, etcetera that they would like to be either associated with or not associated with on a given webpage or in a certain location on a webpage. The system is further configured to provide anti-tamper measures so that web programmers, etc. cannot override the preferences of the registered advertisers (for example the system could prevent attempted insertion of an advertisement that does not fully comply with the parameters set by the registered advertiser).

In another embodiment, the placeholder or physical location of an existing advertisement is enabled with the system's contextual analysis capabilities as explained above. In this embodiment, the placeholder or specific area on a web page is configured to access the system's capabilities via a plugin, script, embedded software, API or other technology as previously explained. For example, instead of the system monitoring all content on a web site, the system can be configured to only monitor one or more locations and areas proximate those locations on a given website. In this embodiment, the placeholder location and the media in proximity to the placeholder is the focus of the system's analysis. Dynamic or continuous contextual analysis can occur on the web page for the placeholder or placeholders in question. This arrangement allows the website owner/publisher, as well as a media provider to the website, to characterize the placeholder based upon the analysis capabilities of the system. In this embodiment, there can be a multitude of statistics or analytics created for one or more placeholders including, but not limited to: 1) The value of a placeholder to media providers in light of the system's analysis; 2) Ranking of placeholders according to any of the system's analysis; 3) Associations between two or more placeholders; 4) Estimation of risk that a placeholder would be associated with certain media content; 5) Creation of risk scores for a given website or placeholder in light of the website's likelihood to incorporate certain media content; and 6) Risk scores for web site publishers or web site hosting providers in light of the website's likelihood to incorporate certain media content. In this embodiment, the system generates tangible value and data for a website owner/publisher to help market their website to various media provider and advertisers.

In another embodiment, the system can be presented to media providers, advertisers, and others in the form of a search engine that allows the user to query the characteristics of websites and placeholders based upon the various criteria mentioned above. In this scenario, a user may desire to see a listing of websites that most closely match the various preferences they have created in the system. A media provider may desire a listing, with ranking characteristics, of all websites that have placeholders or ad insertion space available that conform to the preferences they have created in the system. Thus, the system could perform the novel types of analysis detailed in this disclosure for a multitude of websites on a continuous basis and archive such analysis for searching by users (versus said analysis only occurring dynamically as a user visits the website). The system could comprise a database, cloud-based architecture, or other storage software that is searchable via API or other known method and comprises metrics, analytics, or profile data related to placement of advertisements, placeholders, website locations, or websites. In this embodiment, various contextual data can be queried, types of websites and advertisement performance can be queried, heat maps of various advertisement locations can be searched or queried, sentiment can be queried, mood analysis, or other types of contextual data described herein and collected by the system can be queried for users to determine which locations, which advertisements, which associated content on the website, or which other types of advertisements should be preferred in placing advertisements on a website, within a placeholder, or dynamically created for the advertiser. In this embodiment, the search engine or database is configured to model whether one or more selected parameters match certain placeholders, websites, or other advertisement spaces available and then provide the results to the advertiser based upon a rank, score, or list. For example, the search engine or database could be configured to dynamically decide whether an ad meets or is appropriate for a given web site, placeholder, or other advertising space based upon matching using the machine learning engine, database, search engine, or a matching algorithm. In addition, the database or search engine could be configured to create conditional scenarios that allow the system to automatically place ads when one or more parameters associated with a given ad is met. The search engine is to map the most recent results, metrics, and data from the web, webpages, or advertisements.

In another embodiment and in relation to steps 101-112 as well as FIG. 4, the system is configured to use multiple servers, cloud-based solutions, cloud architecture, multicore processors, edge servers, web servers, APIs, scripts, links, embedded links, parallel processing techniques, serial processing techniques, machine learning, databases, storage, memory, processor, web browsers, data modeling, web crawler techniques, cell phones, tablets, voice control, voice recognition, biometrics, screen viewing software, eye-tracking software, scroll-tracking techniques, smartphones, touchscreen, gesture-tracking software, or encryption techniques alone or in combination to accomplish any of the attributes of the invention discussed herein.

The present invention is being disclosed by reference to certain of its preferred embodiments, and it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method of:
Defining one of more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters.

2. The method of claim 1 wherein:
Said digital media being accessed by a user is altered by removing portions of said digital media that correspond with said summary of parameters.

3. The method of claim 2 wherein:
A software object is inserted in place of said removed portions of said digital media.

4. The method of claim 3 wherein:
Said inserted software object is at least one of text, image, URL, hyperlink, script and audio.

5. The method of claim 1 wherein:
Said digital media are at least one of text-based, visual-based and audio-based types

6. The method of claim 2 wherein:
Said altering of digital media occurs as the result of a user attempting to access said digital media.

7. A method of:
Defining one of more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Sharing said summary with another entity.

8. A method of:
Defining one of more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Altering at least one of content and structural composition of said digital media.

9. A method of:
Defining one of more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Altering at least one of content and structural composition of digital media by removing portions that correlate with said summary parameters; and
Inserting a software object in place of said removed portions; and
Inserting at least one of text, visual and audio media into said software object.

10. The method of claim 9 wherein:
Insertion of said at least one of text, visual and audio media into said software object occurs after the user has begun to access said digital media.

11. A method of:
Defining one of more parameters to be compared to content of first digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Analyzing said first digital media for correlation to said summary parameters; and
Determining if correlating portions of said first digital media contain references to second digital media; and
Analyzing said second digital media for correlation to said summary parameters.

12. The method of claim 11 wherein:
At least one of content and structural composition of said first digital media is altered when said second digital media contains correlations with said summary parameters.

13. A method of:
Defining one of more parameters to be compared to content of digital media; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Performing analysis of digital media for correlation to said summary parameters.

14. The method of claim 13 wherein:
Said analysis is presented to a user in a searchable format.

15. The method of claim 13 wherein:
Said analysis is stored in a database.

16. The method of claim 13 wherein:
Said analysis is shared with an entity in the form of a report.

17. The method of claim 13 wherein:
Said analysis is shared with an entity in the form of a digital interface.

18. The method of claim 13 wherein:
Said analysis is scheduled to be performed automatically on a scheduled basis.

19. The method of claim 13 wherein:
Said analysis is performed only on a portion of said digital media.

20. The method of claim 19 wherein:
Said portion of said media is defined by location on the user display.

21. The method of claim 19 wherein:
Said portion of said media is defined by media types.

22. The method of claim 21 wherein:
Said media types are at least one of text, image, URL, hyperlink, script and audio.

23. A method of:
Defining one or more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Altering at least one of content and structural composition of said digital media by removing portions that correlate with said summary parameters; and
Inserting a software object in place of said removed portions wherein the inserted software object correlates with said parameters.

24. A method of:
Defining one or more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Altering at least one of content and structural composition of said digital media by removing portions that correlate with said summary parameters; and
Blocking insertion of a software object in place of said removed portions wherein the inserted software object does not correlate with said parameters.

25. A method of:
Defining one of more parameters to be compared to content of digital media accessed by a user; and
Analyzing said parameters to determine at least one of related subject matter, keywords, entities, individuals, locations, visual representations and sentiment associated with said parameters; and
Creating a summary of said parameters and at least one of related subject matter, keywords, entities, individuals, locations, visual representations and sentiment associated with said parameters; and
Altering at least one of content and structural composition of said digital media by removing portions that correlate with said summary parameters; and
Inserting a software object in place of said removed portions; and
Inserting at least one of text, visual and audio media into said software object.

26. The method of claim 25 wherein:
Insertion of said at least one of text, visual and audio media into said software object occurs after the user has begun to access said digital media.
